(19) United States
(12) Patent Application Publication
(10) Pub. No.: US 2018/0196395 A1
(43) Pub. Date: Jul. 12, 2018

(54) Timer Apparatus and Method

(71) Applicant: Peter C. Salmon, LLC, Mountain View, CA (US)

(72) Inventor: Peter Colne Salmon, Mountain View, CA (US)

(73) Assignee: Peter C. Salmon, LLC, Mountain View, CA (US)

(21) Appl. No.: 15/403,180

(22) Filed: Jan. 11, 2017

(51) Int. Cl. G04G 9/00; G06F 3/16

(52) U.S. Cl. CPC G04G 9/007; G04G 21/08; G06F 3/167

(57) ABSTRACT

A multi-channel timing device is described that can be completely controlled by a user's voice for hands free operation, and has a wireless communications link to a mobile device. Preferably the timing device comprises a processor, a memory, a display, a microphone, a speaker, a processor, a transceiver, and an audio chip. The memory contains instructions executable by the processor to facilitate the creation, control and reporting of multiple timing channels, for example six or more channels. The audio chip performs speech recognition, speech synthesis, and music synthesis. A rich set of event sequencing scenarios are executable by pairing the timing device with a mobile device, such as locating, retrieving and executing recipes that are preprogrammed in a suitable format in the mobile device. The mobile device can also serve as a surrogate to the user, and the pair of devices can implement an event sequencing system having local or remote control capabilities.

### TECHNICAL FIELD

This invention relates to a multi-channel timing device, and more particularly to a multi-channel timing device that is controllable by voice and is wirelessly connected to a mobile device such as a smart phone.

### CROSS-REFERENCES TO RELATED APPLICATIONS

The following regular U.S. Patent applications are being filed concurrently, and the entire disclosures of the other applications are incorporated by reference into this application for all purposes:

application Ser. No. 62/280,544, filed Jan. 19, 2016, entitled “TIMING APPARATUS AND METHOD”; and

application Ser. No. 62/280,556, filed Jan. 19, 2016, entitled “NETWORKED MULTI-CHANNEL TIMER”; and

application Ser. No. 62/318,967 filed Apr. 6, 2016, entitled “VOICE CONTROLLED AND PHONE CONNECTED TIMING DEVICE”.

### BACKGROUND OF THE INVENTION

Mechanical and electronic timers have been available for several decades. Early timers were typically packaged as single function timers, useful for timing simple cooking events at home or for timing an experiment in a laboratory as examples.

More recently electronic timers have become available with four or more independent timing channels.

Despite the progress made in timing devices and other electronic devices, there is a need in the art for improved devices as well as improved methods for interfacing with them, to simplify and enhance their human interface, to enable more sophisticated event sequences, to time an event sequence where it is not known ahead of time how many independent timers will be required, or when the number of timers required is a large number, for example six or more, or when hands-free operation of the timing device is desired. There is a further need in the art to pair a timer with a mobile device, taking advantage of the processing power of the mobile device to execute both simple and complex scenarios that can be of great benefit to a user, wherein the timing device is a robust, compact and inexpensive companion device that is well suited for use in messy or otherwise challenging environments such as a kitchen, gymnasium, workshop, classroom or laboratory. It is anticipated that the selling price for a timer of the present invention will be substantially less than for a high-end smart phone.

SUMMARY OF THE INVENTION

According to a first embodiment of the present invention, a dedicated multi-channel timing device is provided comprising a microphone, a speaker, a display screen, a processor, a memory, and a voice chip. The processor and the voice chip may be combined in a single integrated circuit chip. The memory contains instructions that are executable by the processor to facilitate the creation, control and reporting of at least six timed intervals, with each timed interval served by a corresponding timing channel. The display screen is configured to display to the user timing channel information and any other requested information. The microphone and the voice chip and the speaker are configured to enable, in cooperation with the processor and the memory, a spoken dialog between a user and the timing device. The timing device is configured to support the following transactions within the spoken dialog: identifying an available channel for use as a new channel; receiving a duration of a new timed interval to be executed on the new channel; displaying the status of the new channel or any other channel when requested by the user; and, signaling the user via voice or musical notes when the new timed interval expires.

In certain contexts, a timed interval may also be referred to as a timing channel, a timing event, or a timer.

The timing device may further comprise a keypad or a touch screen configurable to receive a user's touch input, the touch input to optionally be used in place of some or all of the voiced inputs.

The voice chip and its associated software enable voice recognition and voice synthesis and the generation of music. The voice recognition is configurable to receive voice input through the microphone, and the voice synthesis and music generation are configurable to provide audio output through the speaker. Within this application, voice recognition may be used interchangeably with speech recognition and voice synthesis may be used interchangeably with speech synthesis.

The maximum number of timed intervals supported by the timing device may be a large number, for example more than nine, limited only by the size of the memory and the speed of the processor.

In another embodiment, the dedicated multi-channel timing device may further comprise a transceiver chip configurable to provide for communications between the timing device and a mobile device. The mobile device may be a smart phone or a laptop for example. The transceiver chip may also be configurable to provide for communications between the timing device and electrical appliances within wireless communications range of the timing device. The display screen and the memory may be expanded to accommodate additional information provided by the mobile device. The wirelessly connected system of a multi-channel timing device and a mobile device is capable of many modes of operation, including the servicing of simple scenarios such as downloading a recipe, or more complex scenarios involving two-way communications and multiple types of information. Preferably certain assets of the timing device are configurable and usable by the mobile device acting as an information source or as a surrogate for the user, the certain assets including the display, the memory, the processor, the voice chip, and the transceiver. Among the possible scenarios, the timing device may be controlled primarily by either the user or the mobile device. The mobile device may be programmed to provide information to the timer such as a recipe in a predetermined format that allows a user to retrieve steps of the recipe one-by-one. Additionally, the mobile device may automatically program the timing channels required to implement a recipe. The mobile device may also provide a backup message such as a text message to a user if a timing channel expires and the user does not hear the associated alert, and accordingly does not clear the channel. A person of ordinary skill in the art will be capable of devising a great many scenarios that take advantage of the processing power of the mobile device, coupled with the simple-to-use and robust nature of the timing device, together with its ability to communicate locally with electrical appliances. All such scenarios are claimed for the present patent.

A method for interacting with a timing device is described in another embodiment of the present invention. The timing device comprises a microphone, a speaker, a display screen, a processor, a memory and a voice chip. The memory contains instructions executable by the processor to facilitate the creation, control, and reporting of a plurality of timed intervals. The voice chip is configurable to recognize and synthesize speech, and to play music. The method includes the steps of: requesting by voice input a new channel for executing a new timed interval; programming the new channel with a duration using voice inputs; monitoring status of the new channel using the display screen; and, responding to a voiced output or a series of musical notes when the duration expires. The method may further include the steps of retrieving a recipe from the memory when requested, and optionally displaying steps of the recipe one by one, as prompted by the user. The status of each individual timing channel is preferably reported using a single line of characters on the display screen. The line of characters may comprise a remaining time if the associated timing channel has not yet expired, or an elapsed time since expiration if it has expired. The method may further include the step of scrolling up or down between the lines of characters via a voice command from a user, to select a channel of interest. An addressed line of characters may be highlighted using an arrow symbol, or a distinctive display format such as a different color or flashing characters. Interrogation, revision, or clearing of a timing channel may be accomplished using the voice inputs or the keypad or touch screen inputs, in combination with information displayed on the display screen or provided by voice outputs.

When a timed interval expires, the method may include acting on an external matter that is typically related to the expired duration.

Within the method, some or all of the voice inputs may be replaced by keypad or touch screen inputs.

During the programming step the user may choose between time-of-day and time-from-now as a format for defining the duration of a timed interval. Other formatting options may also be provided, such as choosing between a 12-hour and a 24-hour clock.

Interrogation, revision, or clearing of a highlighted timing channel may be accomplished using the voice inputs in combination with information displayed on the display screen, and optionally in combination with information provided by voice outputs.

By implementing a rich and intuitive human interface incorporating a visual display, a spoken dialog with optional music enhancements, together with optional touch inputs, a user-friendly system may be provided.

Numerous benefits are achieved by way of the present invention over conventional techniques. For example, apart from the ability to read information on the display screen, user interaction with the timing device is achievable entirely by voice input and output transactions, and this base capability can be augmented using music alerts in combination with visual and other aural alerts or cues. Thus, the user can use the timing device intuitively to control sophisticated event sequences in a hands-free manner. A keypad is not required, and if it is provided, it need not be used. The voice inputs and outputs can be effective in any country and with any spoken language, and they can provide a personalized feel to the device. Embodiments of the present invention provide a compact and versatile multi-channel timer having a small footprint, enabling it to be placed on a window ledge, or occupying a small area of a work surface as examples. Preferably the device is portable; it may fit in a user's pocket for example. The wireless connection to a cooperating mobile device such as a smart phone enables a rich set of scenarios. The smart phone may act as a surrogate for a user, having access to many of the assets of the timing device, including the display, the memory, the processor, the voice chip and the wireless transceiver. The smart phone may also act as an information source, for example providing recipes in a step-by-step format for display on the display screen, or as voiced instructions to the user. The programming facilities of the mobile device may be utilized to customize recipes or event sequences that may then be easily transferred to the timer in a standardized format. In summary, the powerful functions of a smart phone may be combined with dedicated and extensive timing functions provided in a timing device of the present invention. Further, the timing device may be operated in adverse environments such as kitchens, laboratories, classrooms, gymnasiums, and other sites that may be inherently messy, dangerous, or inaccessible. In a hostile environment for example, the relatively inexpensive timer may be dispensable.

### BRIEF DESCRIPTION OF THE DRAWINGS

FIG. 1 is a perspective view of a multi-channel timing device of the current invention.

FIG. 2 is a schematic cross-sectional view of the multi-channel timing device of FIG. 1.

FIG. 3 depicts a table of representative user inputs that are voiced, and for each input or input parameter a description of how the timing device may respond, where “#” represents a number relating to a timing parameter that may be voiced by a user, or programmed by the mobile device.

FIG. 4 is a flow chart describing a partial listing of representative steps to implement a cooking scenario using a method of the current invention.

FIG. 5 is a schematic view of an event sequencing system of the present invention comprising a multi-channel timing device in wireless communication with a mobile device and with an electronic appliance.

### DETAILED DESCRIPTION

Various embodiments of the present invention are described hereinafter with reference to the figures. It should be noted that the figures are only intended to facilitate the description of specific embodiments of the invention. They are not intended as an exhaustive description of the invention or as a limitation on the scope of the invention. In addition, an aspect described in conjunction with a particular embodiment of the present invention is not necessarily limited to that embodiment and may be practiced in other embodiments. Additional embodiments may be achievable by combining the various elements in different ways. For example, among the co-pending applications, various combinations of displays, memories, microphones, keypads, processors, mobile devices, voice chips, electronic appliances and speakers are described, together with many methods of using them. So for example, although commanding by voice is a control option, a simple keypad based timer may be combined with a wireless link to a cooperating mobile device, wherein the full processing power and the human interface of the mobile device can be used to retrieve recipes or other information, or to control some or all aspects of the timing device. An example of the mobile device controlling the timing device would be when the mobile device automatically names and starts timers for each of the steps in a selected recipe, or arranges them according to one of many timing channel formats, perhaps including a prompting sequence for the user. In another area, with regard to timer packaging, any of the described designs may utilize a stainless steel faceplate.

As an example of a timing scenario, consider a cook in a restaurant kitchen making a dinner comprising multiple dishes. The names of the timed events could be “potatoes”, “carrots”, “broccoli”, “roast”, “cheese sauce” and “pie” for example. These names may become signatures of the timed intervals. Each item may be displayed on a single line of the display screen, and they may optionally be voiced by the timing device on interrogation of a channel, or when a timed interval expires.

A key requirement of a multi-channel timing device is a convenient method for assisting the user to track which timing channel is associated with each of the timing events (timed intervals). This becomes more important as the number of channels increases. To date, commercial products appear to have ignored this requirement, or have provided a pen and a white board for the user to write the name of each timing event. However, it may be inconvenient for a user to use a pen while having sticky fingers in the kitchen. The pen may run dry. The white board may accumulate unwanted residues from the cooking process. The eraser may be fragile and may fail over time. Since with several timer channels a user may forget which channel represents which activity, an embodiment of the current invention uses a voiced name as a signature of each channel, and the voiced name is replayed when the channel expires or is interrogated by the user.

In an embodiment of the current invention, the multi-channel timing device may be awakened from sleep mode by the user voicing “WAKE UP”. When the processor is in sleep mode, the timing device is preferably configured such that a minimum number of electronic circuits are active. Thereafter the timer wakes up and is ready for user input, to program a new timing channel for example. In this case the user may voice “NEW CHANNEL”, whereupon the timing device provides a new line number on the first display and waits for a voice input corresponding to the new timer channel. The user may then speak the name of a timed interval into the microphone; a facsimile of this spoken name is stored by the processor in the memory, and a speech-recognized version of the name, achieved using the voice chip, is displayed on the new display line. The user may then enter the duration of the timed interval by voicing “# MINUTES”, where “#” is a number, and the timer displays the number of minutes on the new line and starts counting down on this channel. In this case, the number of minutes has been provided as a parameter to the timer in a “time-from-now” format. Other units and formats for timing intervals may be used. For example, the interval can be voiced in hours and minutes and also displayed in hours and minutes, using a different display format. In this case a user may input “2 hours, 14 minutes and 39 seconds” and this might be displayed as “2:14:39” on the display screen. Also a “time-of-day” format may be used to provide the timer parameter for a given timing channel. In this case, the time-of-day mode would be entered by the user voicing “TIME OF DAY”. Then the user may voice “1 30 PM” as an example of the time for expiration of the current interval. In this time-of-day case, the processor may calculate the time in minutes to achieve the desired expiration time, and initialize the corresponding timer to begin counting down accordingly. In another option for the user, a timer channel may be specified with a STARTING TIME (formatted as time-of-day) and a DURATION (formatted as a timing interval), using a different command set. In yet another option, the user may specify a FINISH TIME for all timing channels to expire, perhaps this time of day corresponding to a predetermined meal time. In this case the processor in the timing device or the processor in the mobile device may be used to synchronize the timing events and program the timing channels accordingly.

To accommodate alternative command and display formats, the display screen may be implemented as a high resolution pixelized display, for increased flexibility in placing characters, symbols and graphics in each display area.

If the timing device is battery powered, the display screen may be implemented using liquid crystal display (LCD) technology for reduced power consumption and extended battery life. Alternatively, the timing device may be connected via a power cord to a power source such as a wall socket, whereupon the device will be continually powered and there will be no need for a “WAKE UP” sequence. In this plugged in case, colored display elements may be used for increased visibility and attractiveness of the displays.

In the “time from now” mode the processor in the timer counts down each of the timed intervals to determine the time remaining for each unexpired timed interval, and displays the set of remaining times on the display screen. The processor also determines when each timed interval expires, corresponding to a remaining time of zero. To notify the user, the spoken name of the expired timed interval may be announced and a corresponding expiration message may be repetitively flashed on the display. Audible tones or tone sequences or music excerpts may be combined with replay of the voiced names at various execution points within the overall implementation of a timing event. This process continues until all of the timed intervals have expired, and the user has responded to each of the expired intervals, and after a following predetermined interval the timer may revert to sleep mode.

After expiration of the duration entered for a timing channel, the timing device preferably begins counting up, to show a user the elapsed time since the timed event ended. Elapsed times may be highlighted using flashing characters, or different colored characters for example, and this may prompt the user to clear the channel after any corresponding actions have been taken.

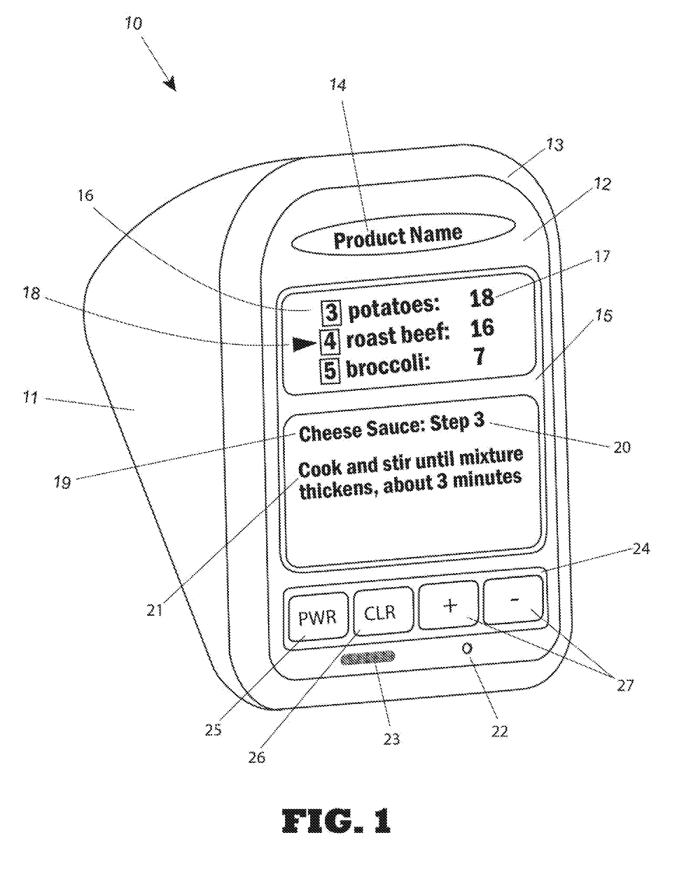

FIG. 1 depicts a timing device 10 comprising an enclosure 11, and a stainless steel face plate 12 having a rounded edge 13. Enclosure 11 may comprise molded plastic for example; however, any type of enclosure may be used. Device 10 preferably includes a product name 14 as shown, and a display screen 15. In a preferred embodiment, display screen 15 comprises multiple display lines 16, each line presenting information about a timing channel. The information preferably includes the number of the timing channel, the name of the timed item, and the time remaining. Different display formats may be used to present the time remaining. For example, the remaining time may be presented using a time-from-now format as shown in FIG. 1 where the digits shown 17 represent minutes. However, other formats such as time-of-day may be used. A symbol such as an arrowhead 18 may be used to highlight an addressed timing channel for programming purposes. The name of the timed item may also be available by audio output through the speaker, using the microphone, speech recognition chip and processor of the mobile device. The display screen may be used to present information to the user, other than timing channel information, to include instructions and prompts to the user for example, possibly also including symbols or graphical elements or pictures of baked dishes. The information presented may be preprogrammed information such as the name 19 of a selected recipe, together with the step number 20 of the recipe, and the corresponding description 21 of actions to be performed by the user. The presented information 21 may be sourced from the memory of timing device 10 or from a companion mobile device. Separate display screens may be used, and they may have separate functions and appearances. Display screens may be implemented using a dot matrix display format, providing flexibility to display multiple formats for text and graphics. As previously discussed, in a battery powered timing device the display screen will preferably be implemented using liquid crystal display (LCD) technology, for low power consumption and long battery life. For a timing device that is connected to continuous power via a power cable plugged into a wall socket, colored dot matrix displays may be preferred, wherein different colors may be used to encode different types of information, and wherein the displays may be observed from a greater distance and may be more attractive to a user. Any type of display technology may be used.

Timing device 10 includes a microphone port 22 and a speaker output port 23. These are preferably located in a user-facing manner as shown, to provide maximum fidelity and reliability of the speech recognition and speech synthesis capabilities of the timing device. In a preferred embodiment, the microphone has a sensitivity of 44 DB, and a frequency range of 100-16,000 Hz. Timing device 10 may also include a keypad as shown. The PWR key 25 may be used for powering device 10 on and off. The CLR key 26 may be used to clear all timing channels. Used together with voice inputs, the “+” and “−” keys 27 may be used for scrolling between display lines, or for raising and lowering the volume output from the speaker.

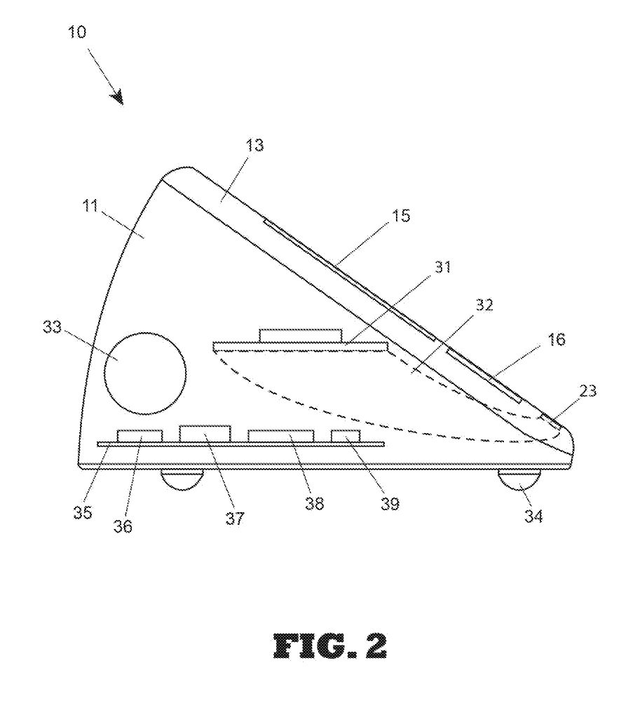

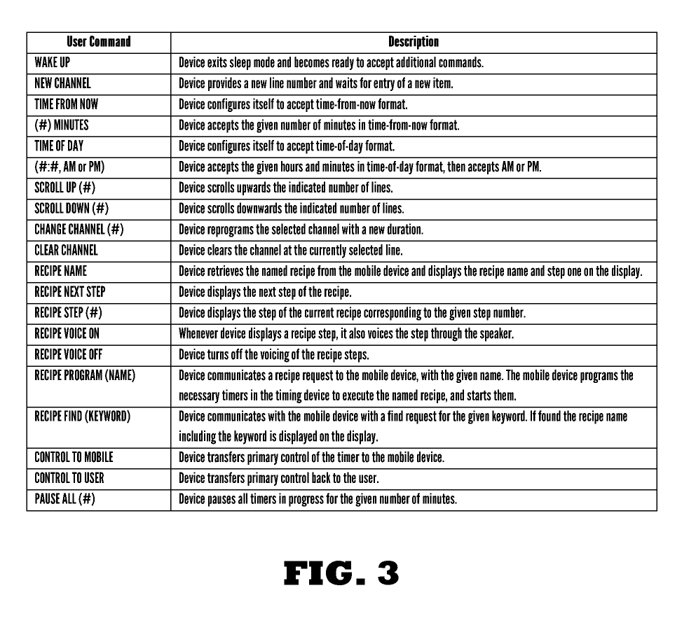

FIG. 2 illustrates timing device 10 in schematic cross-section. Enclosure 11 and rounded edge 13 of the faceplate are shown, along with display screen 15. Inside enclosure 11 are shown a speaker 31, an audio duct 32 used to direct sound energy toward speaker output port 23, and a battery 33. In a preferred embodiment, speaker 31 has 8-ohm impedance, and a power rating of 0.5 W. In a preferred embodiment battery 33 comprises a lithium ion battery of type AAA. However, battery 33 may be of any type, including a rechargeable battery, and device 10 may also be directly powered from a wall socket, not shown. For the case of a rechargeable battery, device 10 may be provided with a charging pad employing resonant inductive coupling technology, not shown. In this case the components of device 10 may be slightly rearranged to provide space near the base for an inductive charging coil. Device 10 is provided with rubber feet 34 so that it will resist sliding on a kitchen counter or other flat surface. A printed circuit board, PCB, 35 is shown with attached components. The attached components may include a processor 36, a memory 37, a wireless transceiver 38, and a voice chip 39. Some of these chips may be combined into more highly integrated chips, or into electronic assemblies. For example, the functions associated with the processor 36, the memory 37, and the voice chip 39 may all be combined on a single chip. Wireless transceiver 38 may be a chip as shown in FIG. 2, or it may be an electronic assembly. It may support wireless communications comprising cellular communications, BLUE TOOTH LOW ENERGY, or a combination of these, or any other form of wireless communications. Transceiver 38 in assembly form may comprise related components such as a baseband processor, a power amplifier and an antenna. Voice chip 39 may comprise functionality similar to that provided by the RSC-4128 speech recognition processor available from SENSORY, INC; preferably it will be programmable to implement speaker independent vocabularies, and will be trainable for optimized voice recognition of a speaker dependent vocabulary, such as exemplified by the user inputs shown in the table of FIG. 3, to be further described. Alternatively, voice chip 39 may also be implemented using another technology such as a tape recording machine. It will typically be capable of playing MP3 files. In a preferred embodiment voice chip 39 will work in tandem with the processor in the timing device, together with their associated software or firmware. This combination will capture the names of timer channels voiced by a user, with around two seconds of voice recording per name, the recorded voice preferably stored in memory, wherein at least some of the memory is configured as programmable memory. Processor 36 may be an 8-bit microcontroller. Memory 37 may be included in processor 36.

In a preferred embodiment, scrolling commands are provided so that a user can navigate to a line of interest displayed on the display screen, the line containing the details of a selected timing channel, highlighted such as by arrow 18 in FIG. 1. The user may scroll up by voicing the command SCROLL UP #, and scroll down by voicing the command SCROLL DOWN #, where “#” refers to a number of lines. Once a selected channel is highlighted it may be changed using a command like CHANGE CHANNEL if the timing channel requires updating, or cleared using a command like CLEAR CHANNEL if it has expired and is no longer needed.

FIG. 3 depicts a table of representative user inputs for use with a timing device of the present invention. Each input is normally voiced by the user. However, the same input can alternatively be sourced from the companion mobile device, wherein it may be voiced using synthesized speech and delivered through the speaker port 18 of FIG. 1. This process will typically follow a pre-scripted recipe that has been suitably formatted, and programmed into a memory residing in the mobile device. Many more user commands may be envisaged by a person of ordinary skill in the art. For example, it may be useful to show an image of a finished dish, particularly if the display screen is implemented as a color display, and for this purpose the user may voice a command like DISPLAY FINISHED DISH. Each of the user inputs shown in FIG. 3 is accompanied by a brief description of a typical response to the command from a timing device such as device 10.

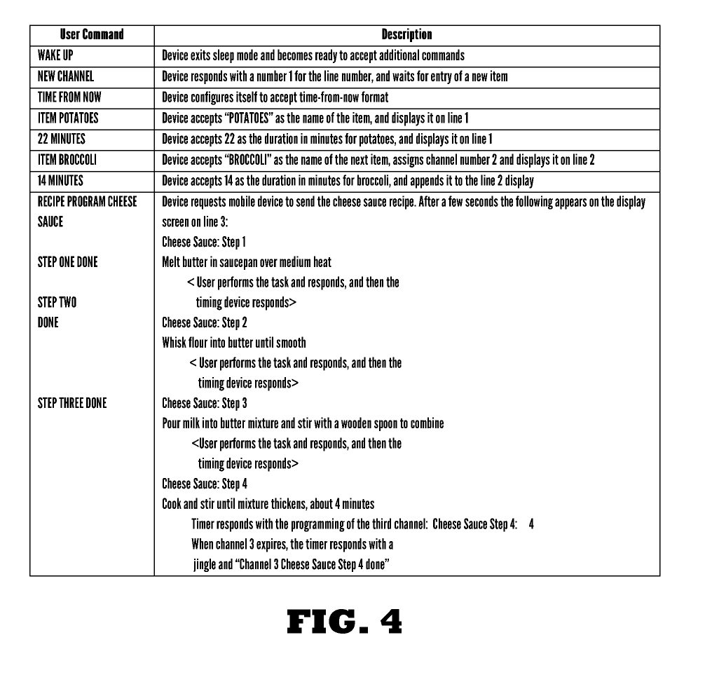

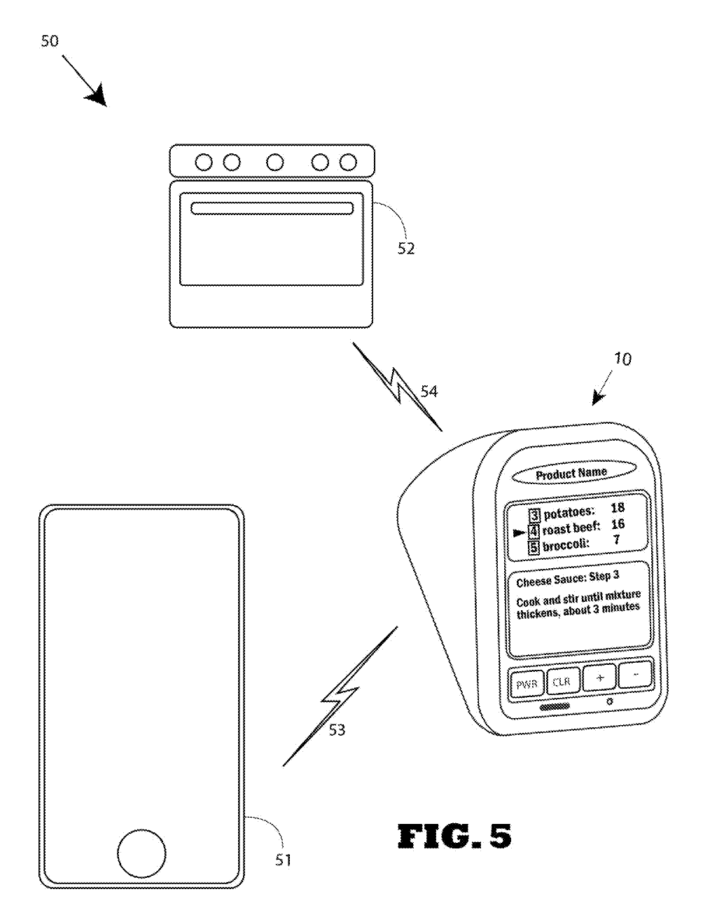

FIG. 4 depicts a simplified flow chart that exemplifies operation of an embodiment of timing device 10 under normal conditions. A sequence of eleven user inputs is depicted, each voiced by the user and captured by the device, the flow defined from top to bottom of the table. Following completion of the steps shown in the table, timers on channels one and two will typically be continuing to count down. A person of ordinary skill in the art will understand that considerable flexibility is available with the given architecture, to be further described in reference to FIG. 5. The architecture comprises a timing device working in concert with a mobile device, the flexibility extending to multiple alternate methods for programming the desired timing channels. The software application running on the mobile device, together with corresponding software or firmware running on the timing device, preferably provides an intuitive flow to the various processes undertaken, to create an event sequencing system that is easy and natural to use.

Timing device 10 can accommodate a large number of timing channels, limited only by the memory 37, for storing the programmed parameters and instructions corresponding to the channels in use, and the processor 36 for executing the instructions required to implement the various timer operations without delays that might frustrate a user. The scrolling capability described in reference to the display screen 15 of FIG. 1 enables a three-line display for example, adequate for a user to navigate among a large number of timing channels. From a user's perspective, the number of channels preferably appears to be unlimited, and this may be attractive in various complex timing scenarios, wherein the total number of required channels may not be known at first.

FIG. 5 illustrates an event sequencing system 50 of the present invention comprising multi-channel timing device 10, a cooperating mobile device 51, and an electrical appliance 52. Electrical appliance 52 may be a kitchen appliance such as the oven shown in the figure, or it may be any other electrical device equipped with wireless communication capabilities. One possible electrical appliance is a wirelessly controlled bank of power sockets, to which multiple appliances can be connected. A bi-directional wireless communications channel 53 is provided between timing device 10 and mobile device 51. Another bi-directional wireless channel 54 is provided between timing device 10 and electrical appliance 52. Communications channels 53 and 54 are preferably implemented in timing device 10 using a single wireless transceiver 38, wherein transceiver 38 may include related components such as a baseband processor, a power amplifier and an antenna, and may be programmed for communication transactions by either the timing device or the mobile device. Once the mobile device has been used to setup system 50, the user may take it with him or her for some other purpose; i.e., the user is not inconvenienced by being without his or her smart phone for longer than a few minutes. In this respect the mobile device and the timing device may be considered as master and slave respectively.

Event sequencing system 50 draws on the processing power and user interface of the mobile device, coupled with the durability, cost-effectiveness, and sophisticated timing capabilities of the timing device. The durability of system 50 enables it to be used in situations that may be messy such as a kitchen, a gymnasium, a workshop or a classroom. The flexibility of the architecture presented in FIG. 5 also enables system 50 to be used in situations that may be dangerous, or when accessibility is limited.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art. For example, wireless communications between the multi-channel timing device and the cooperating devices may include communications in either direction and for any purpose. Messages may be sent that include graphics and audio as well as written instructions, and this may be useful to communicate with individuals such as toddlers for example, who do not yet own or know how to operate a smart phone.

What is claimed is:

1. A dedicated multi-channel timing device comprising:
a microphone;
a speaker;
a display screen;
a processor;
a memory; and,
a voice chip;
wherein the memory contains instructions executable by the processor to facilitate the creation, control and reporting of at least six timed intervals, with each timed interval served by a corresponding timing channel;
wherein the display screen is configured to display to the user timing channel information;
wherein the microphone and the voice chip and the speaker are configured to enable, in cooperation with the processor and the memory, a spoken dialog between a user and the timing device; and,
wherein the timing device is configured to support the following transactions within the spoken dialog:
configuring a new channel when requested by the user; receiving a duration of a new timed interval to be executed on the new channel; displaying the status of the new channel when requested by the user; and, signaling the user via voice or musical notes when the new timed interval expires.

2. The dedicated multi-channel timing device of claim 1, further comprising a keypad or a touch screen configurable to receive a user's touch input.

3. The dedicated multi-channel timing device of claim 1 wherein the voice chip and its associated software enable voice recognition and voice synthesis, the voice recognition configurable to receive voice input through the microphone, and the voice synthesis configurable to provide audio output through the speaker.

4. The dedicated multi-channel timing device of claim 1 wherein the voice chip and its associated software enable music generation, wherein the timing device is configurable to provide the generated music through the speaker.

5. The dedicated multi-channel timing device of claim 1 wherein the display screen is additionally configured to display recipes.

6. The dedicated multi-channel timing device of claim 1 wherein the display screen is additionally configured to display pictures or graphical elements.

7. The dedicated multi-channel timing device of claim 1 further comprising a transceiver configurable to provide for communications between the multi-channel timing device and a mobile device.

8. The dedicated multi-channel timing device of claim 1 further comprising a transceiver configurable to provide for communications between the multi-channel timing device and electrical appliances within wireless communications range of the timing device.

9. A method for using a timing device comprising the steps of:
providing a timing device comprising a microphone; a speaker; a display screen; a processor; a memory containing instructions executable by the processor to facilitate the creation, control and reporting of a plurality of timed intervals; and a voice chip configurable to recognize voice inputs, synthesize speech to create voice outputs, or synthesize music;
requesting by voice input a new channel for executing a new timed interval;
programming the new channel with a duration using voice inputs;
monitoring status of the new channel using the display screen; and,
responding to a voiced output or a series of musical notes when the duration expires.

10. The method of claim 9 further including the steps of:
retrieving a recipe from the memory when requested; and,
displaying steps of the recipe one by one, as prompted by the user.

11. The method of claim 9 including the step of reporting the status of each timing channel using a single line of characters, wherein the line of characters comprises a remaining time if the associated timing channel has not yet expired, or an elapsed time since expiration if the associated timing channel has expired.

12. The method of claim 9 wherein the responding to a voiced output or a series of musical notes includes acting on an external matter.

13. The method of claim 9 wherein some or all of the voice inputs are replaced by keypad or touch screen inputs.

14. The method of claim 9 wherein the programming step allows the user to choose between time-of-day and time-from-now as a format for defining the duration of a timed interval.

15. The method of claim 9 further comprising the steps of:
representing each new channel by a corresponding line of characters; and,
scrolling up or down within the lines of characters to select a channel of interest.

16. The method of claim 9 including the step of highlighting a line of characters using an arrow symbol or other means.

17. The method of claim 13 wherein interrogation, revision, or clearing of a timing channel may be accomplished using the voice inputs or the keypad inputs, in combination with information displayed on the display screen or provided by voice outputs.

18. The method of claim 9, including the step of providing a transceiver chip for communicating between the timing device and other devices including a mobile device, wherein certain assets of the timing device are configurable and usable by the mobile device acting as an information source or as a surrogate for the user, the certain assets including the display, the memory, the processor, the voice chip, and the transceiver.

19. The method of claim 18 further including the steps of:
retrieving a recipe from the mobile device when requested; and,
displaying steps of the recipe one by one, as prompted by the user.

20. The method of claim 18 further including the steps of:
configuring the transceiver to additionally communicate wirelessly with one or more electronic appliances, and,
controlling the other devices, including electrical appliances within range of the transceiver chip, using the transceiver chip.
